(19) United States
(12) Patent Application Publication
(10) Pub. No.: US 2025/0307098 A1
(43) Pub. Date: Oct. 2, 2025

(54) SYSTEM AND METHOD FOR VALIDATING GRAPHS OUTPUTS GENERATED DURING TEST CASE EXECUTION

(71) Applicant: HCL Technologies Limited, NEW DELHI (IN)

(72) Inventors: Srinivas Tangirala, Hyderabad (IN); Narender Siddhamshetty, Hyderabad (IN); Srihari Varadharajan, Chennai (IN); Nidhin A Unnithan, Chennai (IN); Sri Gayathri Paaraa P, Chennai (IN)

(21) Appl. No.: 19/074,521

(22) Filed: Mar. 10, 2025

(30) Foreign Application Priority Data
Mar. 26, 2024 (IN) 202411023797

(51) Int. Cl. G06F 11/263

(52) U.S. Cl. CPC G06F 11/263

(57) ABSTRACT

This disclosure relates to a method and system method validating a graph output generated during test case execution. The method includes receiving a graph output associated with a test step of a plurality of test steps within a test case; receiving, contemporaneous to receiving the graph output, a test case document comprising information corresponding to the test step; extracting a first dataset corresponding to the plurality of graph regions of the graph output and a reference dataset based on the information within the test case document; comparing the first dataset with the reference dataset; and validating the graph output based on the comparison and a predefined validation criteria.

### TECHNICAL FIELD

This disclosure relates generally to software testing, and more particularly to system and method of validating a graph output generated during test case execution.

### BACKGROUND

In a Software Testing Life Cycle (STLC) process, test cases are developed during a test case development phase to test functionalities and features of an application, a product, or a device. The application, the product, or the device under test may go through various levels of testing before it gets released for users or consumers. The test cases may include detailed test steps to verify a specific requirement. The test steps may be executed in a sequence using test automation frameworks. Further, detailed test reports may be generated. During execution of the test cases, when an intermediate output for a test step is a graph image, it requires manual intervention for validating properties of a graph related to a test carried out. A graph output plays a vital role in visualizing complex data across various domains like finance, marketing, medical, sales, stock market, weather forecasting, and the like.

Various conventional test automation frameworks are available for validation of graph outputs. However, the conventional test automation frameworks provide a limited support for various types of graphs in validating all parameters. The conventional test automation frameworks face a challenge in validating various types of graph outputs such as a bar graph, a line graph, a pie chart, a histogram, a stream graph, and the like. The conventional test automation frameworks require human intervention for validation of such types of graph outputs and to execute testcases seamlessly. For example, challenges faced by the conventional automation framework in graph validation include varying reference data formats, such as Excel, Word, PDF, CSV, or image paths, necessitating manual interpretation and verification against graph outputs. Testers face difficulties in identifying minor variations in the properties of the graph, such as a shape and a colour, compared to baseline images, particularly in real-time graph validations. For example, in case of bar graph validations, the testers are required to extract text, values, and color information from test case documents and verify them against corresponding axis (x, y) on the graph. Moreover, validating real-time or production graphs against baseline images poses challenges, particularly in stream graphs, where identifying minor variations in the shape and the colour is difficult. This task demands significant time and effort to achieve accuracy. In some cases, automation flow gets disrupted while validating the graph. If a graph's output is inconsequential to subsequent steps, the conventional test automation frameworks may skip the validation, hence necessitating manual intervention by the testers using available tools.

The present invention is directed to overcome one or more limitations stated above or any other limitations associated with the known arts.

### SUMMARY

In one embodiment, a method for validating a graph output generated during test case execution is disclosed. In one example, the method may include receiving, in real-time, a graph output associated with a test step of a plurality of test steps within a test case. It should be noted that the test case may be developed for testing of a product. The graph output may include a plurality of graph regions. The method may include receiving, contemporaneous to receiving the graph output, a test case document including information corresponding to the test step. Further, the method may include extracting a first dataset corresponding to the plurality of graph regions of the graph output and a reference dataset based on the information within the test case document. It should be noted that the first dataset may be extracted using an Optical Character Recognition (OCR) technique and a Computer Vision (CV) technique. The method may further include comparing the first dataset with the reference dataset. The method may further include validating the graph output based on the comparison and a predefined validation criteria.

In one embodiment, a system for validating a graph output generated during test case execution is disclosed. In one example, the system may include a processor and a memory communicatively coupled to the processor. The memory may store processor-executable instructions, which, on execution, may cause the processor to receive, in real-time, a graph output associated with a test step of a plurality of test steps within a test case. It should be noted that the test case may be developed for testing of a product. The graph output may include a plurality of graph regions. The processor-executable instructions, on execution, may further cause the processor to receive, contemporaneous to receiving the graph output, a test case document including information corresponding to the test step. The processor-executable instructions, on execution, may further cause the processor to extract a first dataset corresponding to the plurality of graph regions of the graph output and a reference dataset based on the information within the test case document. It should be noted that the first dataset may be extracted using an Optical Character Recognition (OCR) technique and a Computer Vision (CV) technique. The processor-executable instructions, on execution, may further cause the processor to compare the first dataset with the reference dataset. The processor-executable instructions, on execution, may further cause the processor to validate the graph output based on the comparison and a predefined validation criteria.

In one embodiment, a non-transitory computer-readable medium storing computer-executable instructions for validating a graph output generated during test case execution is disclosed. In one example, the stored instructions, when executed by a processor, may cause the processor to perform operations including receiving, in real-time, a graph output associated with a test step of a plurality of test steps within a test case. It should be noted that the test case may be developed for testing of a product. The graph output may include a plurality of graph regions. The operations may further include receiving, contemporaneous to receiving the graph output, a test case document including information corresponding to the test step. The operations may further include extracting a first dataset corresponding to the plurality of graph regions of the graph output and a reference dataset based on the information within the test case document. It should be noted that the first dataset may be extracted using an Optical Character Recognition (OCR) technique and a Computer Vision (CV) technique. The operations may further include comparing the first dataset with the reference dataset. The operations may further include validating the graph output based on the comparison and a predefined validation criteria.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an exemplary environment in which various embodiments may be employed.

FIG. 2 illustrates a functional block diagram of various modules within a memory of a validation device configured for validating a graph output generated during test case execution, in accordance with some embodiments.

FIG. 3 illustrates a control logic for validating a graph output generated during test case execution, in accordance with some embodiments of the present disclosure.

FIG. 4 illustrates a flow diagram of an exemplary process for validating a graph output generated during test case execution, in accordance with some embodiments of the present disclosure.

FIG. 5 illustrates a flow diagram of an exemplary process for validating the graph output upon extracting a reference dataset from a reference image, in accordance with some embodiments of the present disclosure.

FIG. 6 illustrates an exemplary visual explanation of a failed validation result generated for a graph output using an external dataset, in accordance with some embodiments of the present disclosure.

FIGS. 7A-7B illustrate an exemplary scenario of generating a visual explanation of a successful validation result for a graph output using an external dataset, in accordance with some embodiments of the present disclosure.

FIGS. 8A-8B illustrate an exemplary scenario of generating a visual explanation of a failed validation result for a graph output using a baseline graph image, in accordance with some embodiments of the present disclosure.

FIGS. 9A-9B illustrate an exemplary scenario of generating a successful validation result for a graph output based on information within a test step, in accordance with some embodiments of the present disclosure.

FIG. 10 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

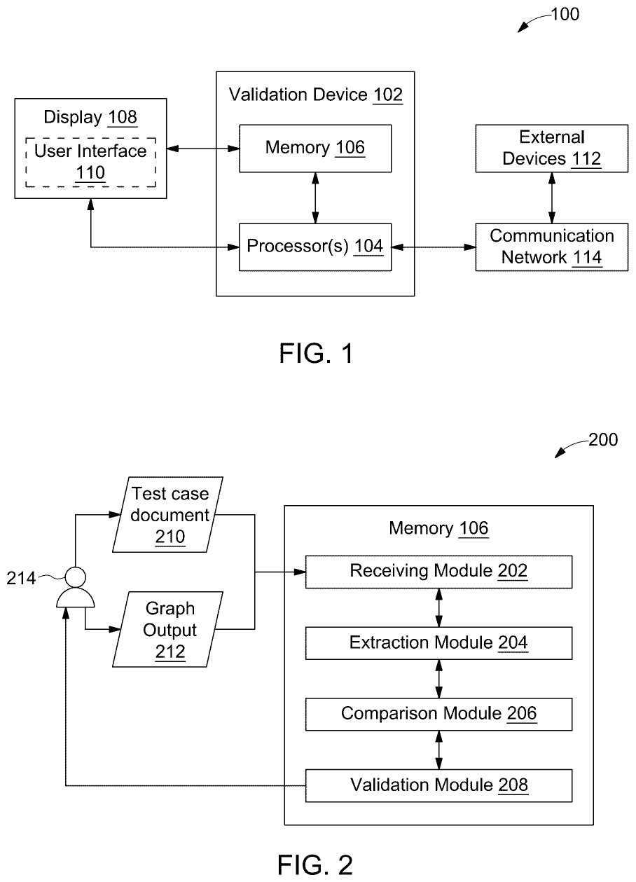

Referring now to FIG. 1, an exemplary environment 100 in which various embodiments may be employed is illustrated, in accordance with some embodiments of the present disclosure.

The environment 100 may include a validation device 102. Examples of the validation device 102 may include, but are not limited to, a desktop, an application server, a laptop, a notebook, a netbook, a tablet, a smartphone, a mobile phone, or any other computing device. The validation device 102 may validate a graph output generated during test case execution. As will be described in greater detail in conjunction with FIGS. 2-10, the validation device 102 may receive, in real-time, the graph output associated with a test step of a plurality of test steps within a test case. It should be noted that the test case may be developed for testing of a product. The graph output may include a plurality of graph regions. The validation device 102 may receive, contemporaneous to receiving the graph output, a test case document including information corresponding to the test step. The validation device 102 may further extract a first dataset corresponding to the plurality of graph regions of the graph output and a reference dataset based on the information within the test case document. It should be noted that the first dataset may be extracted using an Optical Character Recognition (OCR) technique and a Computer Vision (CV) technique. The validation device 102 may compare the first dataset with the reference dataset. The validation device 102 may validate the graph output based on the comparison and a predefined validation criteria.

In some embodiments, the validation device 102 may include one or more processors 104 and a memory 106. The memory 106 may include a database (not shown in FIG. 1). Further, the memory 106 may store instructions that, when executed by the one or more processors 104, cause the one or more processors 104 to validate the graph output generated during test case execution by performing operations such as receiving the graph output, receiving the test case document, extracting datasets, comparing the datasets, identifying an image path, identifying an external path, computing similarity scores, generating visual explanations, and the like. The memory 106 may also store various data (for example graph outputs (such as bar, line, pie chart, histogram, stream, and the like), various datasets, validation results, reference dataset, baseline images, test steps, and the like) that may be captured, processed, and/or required by the validation device 102. The memory 106 may be a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random Access Memory (DRAM), Static Random-Access memory (SRAM), etc.)

The environment 100 may further include a display 108. The validation device 102 may interact with a user via a user interface 110 accessible via the display 108. By way of an example, the validation device 102 may send the validation results on the display 108. By way of another example, the validation device 102 may receive a user input (such as the graph output, the test case document, the validation criteria, and the like) through the user interface 110. The environment 100 may also include one or more external devices 112. In some embodiments, the display 108 may be within the one or more external devices 112. In some other embodiments, the one or more external devices 112 may have their inbuilt display and user interface. Examples of the one or more external devices 112 may include, but are not limited to, a desktop, an application server, a laptop, a notebook, a netbook, a tablet, a smartphone, a mobile phone, or any other computing device.

In some embodiments, the validation device 102 may interact with the one or more external devices 112 over a communication network 114 for sending or receiving various data. By way of an example, the validation device 102 may send the validation result or the visual explanation to the external devices 112. By way of another example, the validation device 102 may receive inputs from the one or more external devices 112, such as graph outputs, test cases, reference datasets, and the like, via the communication network 114. The communication network 114, for example, may be any wired or wireless communication network and the examples may include, but may be not limited to, the Internet, Wireless Local Area Network (WLAN), Wi-Fi, Long Term Evolution (LTE), Worldwide Interoperability for Microwave Access (WiMAX), and General Packet Radio Service (GPRS).

Referring now to FIG. 2, a functional block diagram 200 of various modules within the memory 106 of the validation device 102 configured for validating a graph output 212 generated during test case execution is illustrated, in accordance with some embodiments of the present disclosure. FIG. 2 is explained in conjunction with FIG. 1. To validate the graph output, the memory 106 may include a receiving module 202, an extraction module 204, a comparison module 206, and a validation module 208. Also, the memory 106 may include a datastore (not shown in FIG. 2) that may store various data and intermediate results generated by the modules 202-208.

The receiving module 202 may be configured to receive, in real-time, the graph output 212 associated with a test step of a plurality of test steps within a test case from a user 214. The graph output 212 may correspond to a real-time image or a production image. The real-time or the production image may be captured during test case executions related to a test scenario performed by a test automation framework. The graph output 212 may be an image in at least one of image formats such as Joint Photographic Experts Group (JPEG), Joint Photographic Group (JPG), Bitmap (BMP), Portable Network Graphics (PNG), and the like. It should be noted that the test case may be developed for testing of a product. Further, the graph output 212 may include a plurality of graph regions.

In some embodiments, the receiving module 202 may be configured to receive, contemporaneous to receiving the graph output 212, a test case document 210 from the user 214. The test case document 210 may include information corresponding to the test step. A format of the test case document 210 may be one of a Comma-Separated Values (CSV), Excel Spreadsheet (XLSX), Portable Document Format (PDF), DOCX and the like. The information corresponding to the test step provided in the test case document 210 may be considered as a value to be validated in the graph output 212. The test case document 210 may act as an input and may include information such as test steps, test data, expected results, and the like. Information provided for the test step may vary on case-to-case basis. For example, a reference dataset may be a part of the test step, or may point to an external path, a location, or an image path to fetch the reference dataset. The receiving module 202 may be communicatively coupled to the extraction module 204.

The extraction module 204 may be configured to extract a first dataset corresponding to the plurality of graph regions of the graph output 212. Further, the extraction module 204 may also be configured to extract the reference dataset based on the information within the test case document 210. The extraction module 204 may include an Optical Character Recognition (OCR) model and a Computer Vision (CV) model (not shown in FIG. 2). The first dataset may be extracted using an OCR technique and a CV technique. It should be noted that the first dataset corresponds to an actual result of the test step. Also, it should be noted that the reference dataset corresponds to an expected result of the test step. Further, in some embodiments, the extraction module 204 may identify an image path within the information corresponding to the test step. The image path may point to the reference image. The reference image may be within an image data repository. Further, upon identifying the image path, the reference dataset may be extracted from the reference image within the image data repository through the OCR technique and the CV technique.

In some embodiments, to extract the reference dataset, the extraction module 204 may identify the reference dataset within the information corresponding to the test step. Alternatively, in some embodiments, the extraction module 204 may identify an external path within the information corresponding to the test step. The external path may point to the reference dataset. Further, upon identifying the external path, the reference dataset may be extracted from an external repository. The reference dataset may include details like color of plotted area (such as a bar, a line, etc.), digits, value ranges, text, and the like, for single or multiple validations based on a requirement. The reference dataset required for validating the graph output 212 may include data such as a colour, range of values, digits, and the like. The extraction module 204 may be communicatively coupled to the comparison module 206.

The comparison module 206 may be configured to compare the first dataset with the reference dataset. In some embodiments, a mismatch may be identified between the first dataset and the reference dataset, as a result of the comparison. The comparison module 206 may be communicatively coupled to the validation module 208.

The validation module 208 may be configured to validate the graph output 212 based on the comparison and a predefined validation criteria. For, example when the image path is identified and further the reference dataset is extracted from the reference image, a similarity score may be computed based on a similarity between the first dataset and the reference dataset extracted from the reference image through a similarity analysis. The graph output 212 may be validated based on the similarity score and the predefined validation criteria. Here, in case of the reference image, the pre-defined validation criteria may be a threshold.

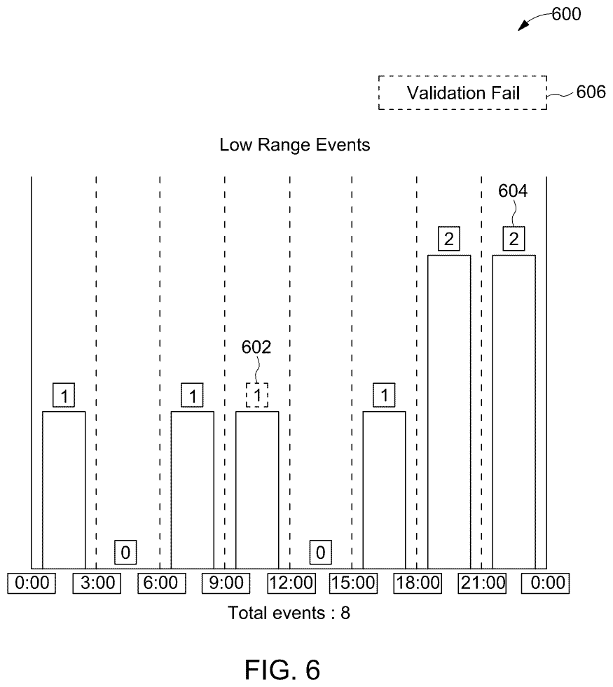

In some embodiments, the validation module 208 may create boundaries around one or more elements in the graph output 212 based on a match in the first dataset and the reference dataset, and the mismatch. The boundaries may include a first type of boundary indicating the match and a second type of boundary indicating the mismatch. This is explained with examples in FIGS. 6-9. Further, the validation module 208 may generate a validation result including at least one of a successful validation or an unsuccessful validation. A visual explanation of validation may be generated. The visual explanation may include the graph output 212 with the boundaries around the one or more elements and the validation result. In some embodiments, the validation module 208 may render the visual explanation to the user 214.

It should be noted that all such aforementioned modules 202-208 may be represented as a single module or a combination of different modules. Further, as will be appreciated by those skilled in the art, each of the modules 202-208 may reside, in whole or in parts, on one device or multiple devices in communication with each other. In some embodiments, each of the modules 202-208 may be implemented as dedicated hardware circuit comprising custom application-specific integrated circuit (ASIC) or gate arrays, off-the-shelf semiconductors such as logic chips, transistors, or other discrete components. Each of the modules 202-208 may also be implemented in a programmable hardware device such as a field programmable gate array (FPGA), programmable array logic, programmable logic device, and so forth. Alternatively, each of the modules 202-208 may be implemented in software for execution by various types of processors (e.g., processor 104). An identified module of executable code may, for instance, include one or more physical or logical blocks of computer instructions, which may, for instance, be organized as an object, procedure, function, or other construct. Nevertheless, the executables of an identified module or component need not be physically located together, but may include disparate instructions stored in different locations which, when joined logically together, include the module and achieve the stated purpose of the module.

As will be appreciated by one skilled in the art, a variety of processes may be employed for validating the graph output generated during test case execution. For example, the validation device 102 may validate the graph output generated during test case execution by the processes discussed herein. In particular, as will be appreciated by those of ordinary skill in the art, control logic and/or automated routines for performing the techniques and steps described herein may be implemented by the validation device 102 either by hardware, software, or combinations of hardware and software. For example, suitable code may be accessed and executed by the one or more processors on the validation device 102 to perform some or all of the techniques described herein. Similarly, application specific integrated circuits (ASICs) configured to perform some or all of the processes described herein may be included in the one or more processors on the validation device 102.

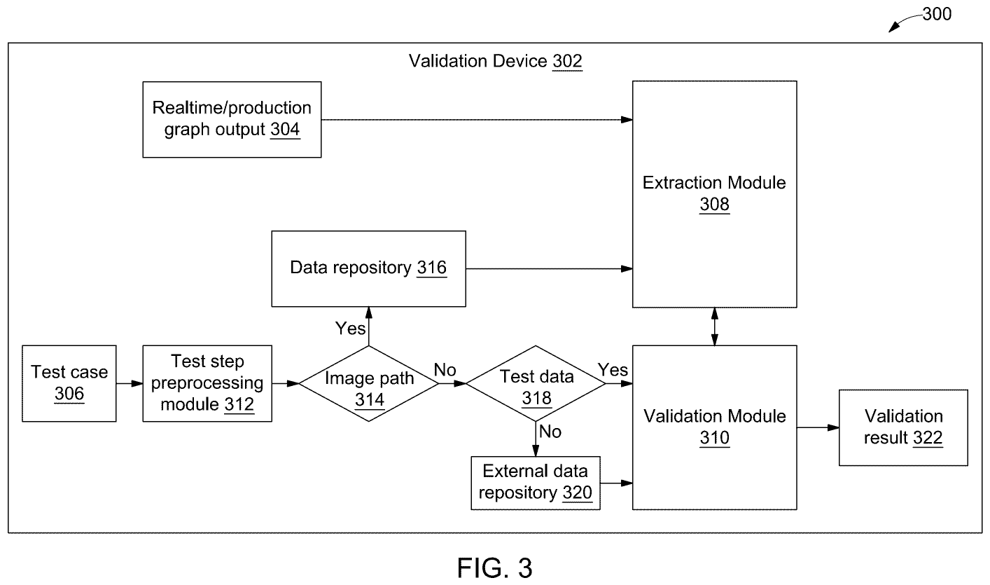

Referring now to FIG. 3, a control logic 300 for validating a graph output generated during test case execution is depicted, in accordance with some embodiments of the present disclosure. FIG. 3 is explained in conjunction with FIGS. 1-2. The control logic 300 illustrates a graph validation process by automating assessment of various elements such as pixel attributes, colors, shapes, areas, textual content, and graph representations within test reports, eliminating a need for manual intervention. The control logic 300 enables test automation frameworks to effectively conduct graph validations, accommodating diverse input combinations for analysis. Thus, the testing process may become more efficient and accurate, ultimately enhancing overall testing efficiency while ensuring reliability of results.

The control logic 300 may include a validation device 302 (such as the validation device 102). As illustrated in FIG. 3, in some embodiments, a real-time or production graph output 304 (such as the graph output 212) may be received as an input. It should be noted that terms “graph output”, “real-time graph output”, and “production graph output” are used interchangeably in the present disclosure. The real-time or production graph output 304 may be an image that may be received along with a test case 306. As the real-time or production graph output 304 is an image, the real-time or the production graph output 304 may be in one of formats including JPEG, JPG, BMP, PNG or the like. The real-time or production graph output 304 may be captured during a test case execution related to a test scenario performed by a test automation framework.

The real-time or production graph output 304 may be passed to an extraction module 308 (such as the extraction module 204). The extraction module 308 may be configured to extract a first dataset from the real-time or the production graph output 304. For example, the extraction module 308 may extract text using an Optical Character Recognition (OCR) technique from the real-time or the production graph output 304. Further, the extraction module 308 may extract content like colour, or shape of real-time or production graph output 304 using a Computer Vision (CV) technique. The extraction module 308 may be capable of identifying different graph patterns and types of extraction methods to be performed. The first dataset extracted by the extraction module 308 may be passed a validation module 310 (same as the validation module 208) for validation process.

The test case 306 may be received for the validation process. The test case 306 may be a document in at least one of file formats such as CSV, XLSX, PDF, DOCX, etc. The test case 306 may include a detailed test step for validating the requirements. The document of the test case 306 may be passed to a test step preprocessing module 312 to process information present in the test step. Further, at step 314, it may be checked if an image path to a data repository 316 which includes a baseline image (same as the reference image) is present in the test step. In case the image path is present, the baseline image may be processed to the extraction module 308 or the baseline image may be extracted by the extraction module 308. Further, a test data (such as the reference dataset) may be extracted by the extraction module 308 from the baseline image using the OCR and CV techniques. Further, the first dataset extracted from the real-time or production graph output 304 along with the test data extracted from the baseline image may be transmitted to the validation module 310. It should be noted that the image path may be provided in the test step when the real-time or production graph output 304 needs to be compared with the baseline image.

Otherwise, when the image path is unavailable in the test step, at step 318, it may be checked if the test data is present for the test step that may vary on case-to-case basis. For example, the test data may be a part of the test step, or it may be pointing to an external path or a location to fetch the test data. If the test data is directly present in the test step, the test data may be processed to the validation module 310 If the test data is absent in the test step and the external path is present, in such a case, the test data may be extracted from an external data repository 320 by the validation module 310. The test data may include validation information for the real-time or production graph output 304 such as colour, range of values, digits, and the like, which are provided in a text format and passed to the validation module 310. The validation module 310 may perform validation and provide a match score. All validated data may be highlighted in the image of the real-time/production graph output 304 and a validation result 322 of “Validation Pass” or “Validation Fail” may be appended to the image to notify a user. The validation module 310 may also provide additional reports on case-to-case basis.

It should be noted that the CV technique may be used for colour detection and differentiation of the graphs. For example, in a stream graph, colour shades may vary from one layer to another layer with minute differences, where each layer is required to be detected and validated separately. By way of another example, in a line graph, there may be an overlap between lines where chances of mixing of colours are high or the colours may mix or dominate one another. Thus, there is a high possibility to trace the colours in overlapping scenarios along with its flow and direction as there are high chances it may mislead. Thus, the CV technique may be used for colour detection and differentiation of the graphs.

Further, the OCR technique may be configured to extract the text content from the image. The OCR technique may be referred to as Deep Learning (DL) OCR, in accordance with some embodiments of the present invention.

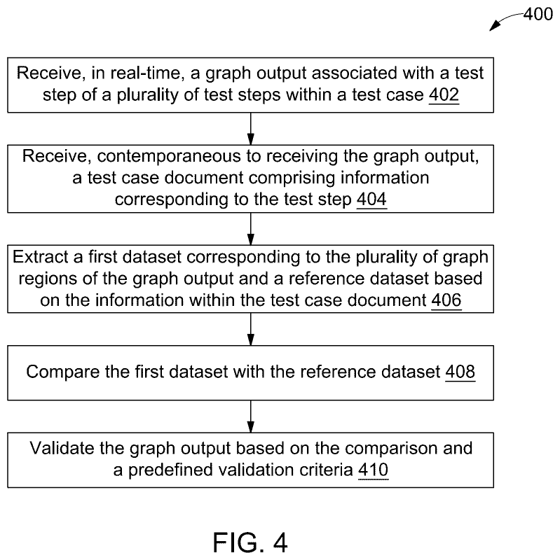

Referring now to FIG. 4, an exemplary process 400 for validating a graph output generated during test case execution is depicted via a flowchart, in accordance with some embodiments of the present disclosure. FIG. 4 is explained in conjunction with FIGS. 1-3. Each step of the process 300 may be implemented by a validation device (such as the validation device 102, and the validation device 302).

At step 402, a graph output (for example, the graph output 212 or the real-time or production graph output 304) associated with a test step of a plurality of test steps within a test case (such as the test case 306) may be received in real time. This step may be performed using a receiving module (same as the receiving module 202). It should be noted that the test case may be developed for testing of a product. The graph output may include a plurality of graph regions. The graph output 212 may correspond to a real-time image or a production image. The real-time image may be captured during test case executions related to a test scenario performed by a test automation framework. Further, the graph output may be an image in at least one of formats such as JPEG, JPG, BMP PNG and the like.

At step 404, contemporaneous to receiving the graph output, a test case document (same as the test case document 210) including information corresponding to the test step may be received via the receiving module. A format of the test case document may be one of a Comma-Separated Values (CSV), an Excel Spreadsheet (XLSX), a Portable Document Format (PDF), a DOCX, and the like. The information corresponding to the test step provided in the test case document may be considered as a value to be validated in the graph output. The test case document may act as an input and may include information such as test steps, test data, expected results, and the like. The information provided for the test step may vary on case-to-case basis. For example, a reference dataset may be a part of the test step, or may point to an external path or location, or an image path to fetch the reference dataset.

At step 406, a first dataset corresponding to the plurality of graph regions of the graph output and the reference dataset based on the information within the test case document may be extracted. This step may be performed using an extraction module (such as the extraction module 204 and the extraction module 308). It should be noted that the first dataset may correspond to an actual result of the test step and the reference dataset may correspond to an expected result of the test step. The first dataset may be extracted using an Optical Character Recognition (OCR) technique and a Computer Vision (CV) technique. In some embodiments, an image path within the information corresponding to the test step may be identified. The image path may point to the reference image. The reference image may be within an image data repository (such as the data repository 316). Further, upon identifying the image path, the reference dataset may be extracted from the reference image within the image data repository through the OCR technique and the CV technique.

In some embodiments, to extract the reference dataset, the reference dataset within the information corresponding to the test step may be identified. Alternatively, in some embodiments, an external path within the information corresponding to the test step may be identified. The external path may point to the reference dataset. Further, upon identifying the external path, the reference dataset may be extracted from an external repository (for example the external data repository 320). The reference dataset may Include details like color of plotted area (such as a bar, line, etc.), digits, value ranges, text, and the like, for single or multiple validations based on a requirement.

At step 408, the first dataset may be compared with the reference dataset through a comparison module (for example, the comparison module 206). In some embodiments, a mismatch in the first dataset and the reference dataset may be identified.

At step 410, the graph output based on the comparison and a predefined validation criteria may be validated using a validation module (for example, the validation module 208 and the validation module 310). For, example when the image path is identified and further the reference dataset is extracted from the reference image, a similarity score (for example, 45, 8, 90, 40, 50, and the like) may be computed based on a similarity between the first dataset and the reference dataset extracted from the reference image through a similarity analysis. The graph output may be validated based on the similarity score and the predefined validation criteria. Here, the pre-defined validation criteria may be a threshold (for example, 80, 40, 90, 10, or any other value). The threshold may be a pre-set by a user, or a tester based on requirements. For example, consider a scenario where the threshold is “90” and the similarity score is “85”, in such as case the validation may be failed, as the similarity score “85” is below the threshold “90”. On the other hand, if the similarity score is “93”, the validation may be successful, as the similarity score “93” is above the threshold “90”. The validation criteria is not only restricted to the threshold, it may vary depending on a type of validation or the reference dataset received.

In some embodiments, boundaries may be created around one or more elements in the graph output based on a match and the mismatch in the first dataset and the reference dataset. The boundaries may include a first type of boundary indicating the match and a second type of boundary indicating the mismatch. For example, a green colour boundary may be used to represent the match and a red color boundary may be used for the mismatch. Further, a validation result may be generated. The validation result may include at least one of a successful validation or an unsuccessful validation. A visual explanation of validation may be generated. The visual explanation may include the graph output with the boundaries around the one or more elements and the validation result. This is further explained with examples in conjunction with FIGS. 6-9

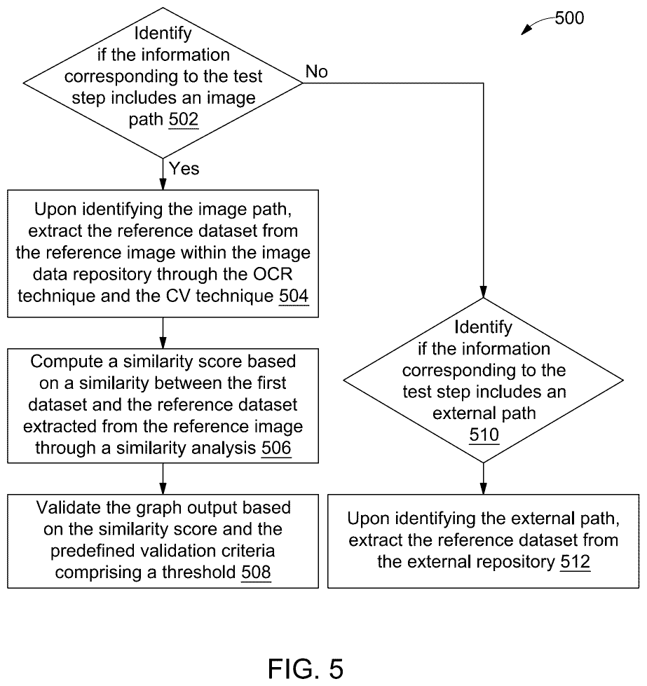

Referring now to FIG. 5, an exemplary process 500 for validating the graph output upon extracting a reference dataset from a reference image is depicted via a flowchart, in accordance with some embodiments of the present disclosure. Each step of the flowchart is executed by the validation device 102. FIG. 5 is explained in conjunction with FIG. 4.

At step 502, it may be identified if an image path is present within the information corresponding to the test step. It should be noted that the image path points to the reference image. The reference image may be within an image data repository (such as the data repository 316). At step 504, upon identifying the image path within the information, the reference dataset may be extracted from the reference image. The reference dataset may be extracted using the OCR and CV techniques. Further, at step 506, a similarity score may be computed based on a similarity between the first dataset and the reference dataset extracted from the reference image through a similarity analysis.

At step 508, the graph output may be validated based on the similarity score and the predefined validation criteria. Here, the validation criteria may include a threshold. The validation may be a successful validation or an unsuccessful validation. For example, consider a scenario where the threshold is “90” and the similarity score is “85”, in such as case the validation may be failed, as the similarity score “85” is below the threshold “90”. On the other hand, if the similarity score is “93”, the validation may be successful, as the similarity score “93” is above the threshold “90”.

Alternatively, when the image path is absent in the information, at step 510, it may be identified if an external path within the information corresponding to the test step is present. It should be noted that the external path may point to the reference dataset. The reference dataset may be within an external data repository (such as the external data repository 320). At step 512, upon identifying the external path, the reference dataset may be extracted from the external repository.

Referring now to FIG. 6, an exemplary visual explanation 600 of a failed validation result generated for a graph output (such as the graph output 212 and the real-time or production graph output 304) using an external dataset (such as the reference dataset within a test step or fetched from the external data repository 320) is illustrated, in accordance with some embodiments of the present disclosure. FIG. 6 is explained in conjunction with FIGS. 1-5.

In this scenario, an image of the graph output received may be same as a graph image of the visual explanation 600 of the failed validation result. However, the image of the graph output may not include boundaries (such as a second type of boundary 602, and a first type of boundary 604) and a text 606 labeled as “Validation Fail” represented in the visual explanation 600 of the failed validation result. The image of the graph output may be an outcome of the test step executed from a test case document. Test data provided in a test step may be considered as a value to be validated in the graph output. A validation type may be changed based on the test data provided. The test case document may act as an input and may include information such as the test step, the test data, expected results, etc. The test step may include details like color of a plotted area (i.e., bar, line, etc.), digits, value ranges, text, etc., for single/multiple validations based on a requirement. In such cases where multiple specification is provided in the test step or the test data, the required information may be picked for validation of the graph output. In case of single specification, it may be validated directly. For example, in test cases where measurements may be provided for test data as kilometer/mile, milligram/gram, etc., in such cases data selection may be based on units represented in the graph output. The units may be represented in the image of the output graph as “km” then values related to “km” may be selected from the test data for validation and in case of “mile” then data related to “mile” may be selected from the test data for validation.

As illustrated in FIG. 6, the graph output includes bars and text information. A first dataset to be validated may be extracted from the graph output. Further, this data (i.e., the first dataset) may be compared with the external data. By way of an example, consider that the external data may include the test data and an expected result corresponding to the test step. The test step may include “Low range events report validation for events displayed on screen with total 8 events and expected values”. The test data may include data for validation of the first dataset with respect to various time intervals. The test data may correspond to the reference dataset. For example, the reference dataset for the time intervals may be given as “00:00-03:00-1”, “03:00-06:00-0”, “06:00-09:00-1”, “09:00-12:00-2”, “12:00-15:00-0”, “15:00-18:00-1”, “18:00-21:00-2”, “21:00-00:00-2”. It means for the time interval “00:00-03:00”, corresponding data is “1”. Similarity, for other time intervals dataset has been provided. The expected result may be “The low range events that display a bar graph showing the count of events corresponding to each bar and values are in rage with test data”.

Further, when the first dataset extracted from the graph output is compared with the test data, a mismatch may be found. For example, a value corresponding to the time interval “09:00-12:00” in the test data is “2”, however in the first dataset it is “1”. Thus, the second type of boundary 602 may be created around this mismatch value “1”, while generating the visual explanation 600 of the failed validation result. As the mismatch is found in the first dataset and the test data, the text “Validation Fail” may also be appended in the visual explanation 600. For example, the second type of boundary 602 may be created in a red colour. Further, a first type of boundary 604 may be created around matching data between the first dataset and the test data. For example, the first type of boundary 604 around the matching data may be in a green color. Here, for brevity, one example of using different colors for creating boundaries for differentiation of matches and mismatches is mentioned. However, alternative methods, such as employing different shapes to represent mismatches and matches, may also be utilized.

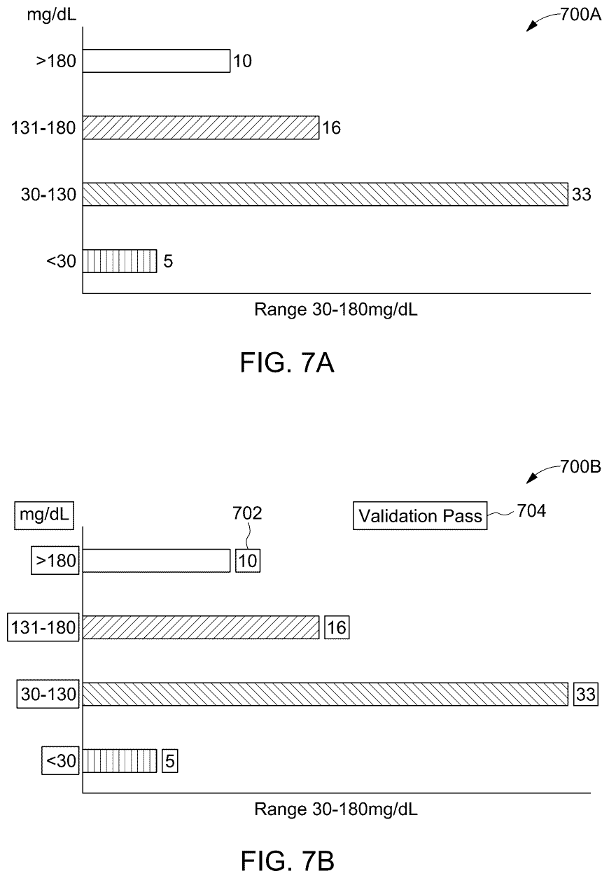

Referring now to FIGS. 7A-7B, an exemplary scenario of generating a visual explanation 700B of a successful validation result for a graph output 700A (such as the graph output 212 and the real-time or production graph output 304) using an external dataset (such as the reference dataset within a test step or fetched from the external data repository 320) is illustrated, in accordance with some embodiments of the disclosure. FIGS. 7A-7B are explained in conjunction with FIGS. 1-6.

In FIG. 7A, the graph output 700A is illustrated. Bars in the graph output 700A and the visual explanation 700B are represented with different patterns such as a hollow bar, a bar with slanting lines to the right, a bar with slanting lines to the left, a bar with vertical lines. These patterns correspond to different colors differentiating complexity involved. For example, the hollow bar corresponds to a blue colour, the bar with slanting lines to the right corresponds to a green colour, the bar with slanting lines to the left corresponds to a brown colour, and the bar with vertical lines corresponds to a yellow colour. This is one example which is explained, however other colours and patterns may be used to represent different complexities. In some embodiments, a first dataset may be extracted from the graph output 700A for validation of the graph output 700A. Further, consider that the external data required for validation of the graph output 700A may include test data and an expected result corresponding to a test step. The test data may be used based on parameters of the graph output 700A.

The test data may include data or values with respect to various ranges. For example, the test data for mg/dl may include “target range>180 is 10”, “target range 131-180 is 16”, “target range 30-130 is 33”, and “target range<30 is 5”. Further, for example, the test data for mmol/L may include “target range>20.3 is 5.2”, “target range 12.1-20.2 is 16.0”, “target range 6.5-12.0 is 53.1”, and “target range<6.4 is 1.0”. The expected result may be “target report displays the historical values in the time period”.

Further, during a comparison between the first dataset extracted from the graph output 700A and the test data, it may be observed that there are no discrepancies or mismatches. For example, all values with respect to various ranges in the first dataset matches values with respect to various ranges in the test data. Consequently, a first type of boundary 702 may be created around matching data in the graph output 700A, while generating the visual explanation 700B of the successful validation result. Thus, the visual explanation 700B includes only the first type of boundary 702 around the matches. The first type of boundary may be created in a green colour. Furthermore, as a part of the visual explanation 700B, a text 704 labeled “Validation Pass” may be incorporated to signify the successful validation outcome, ensuring clarity and comprehension of the result.

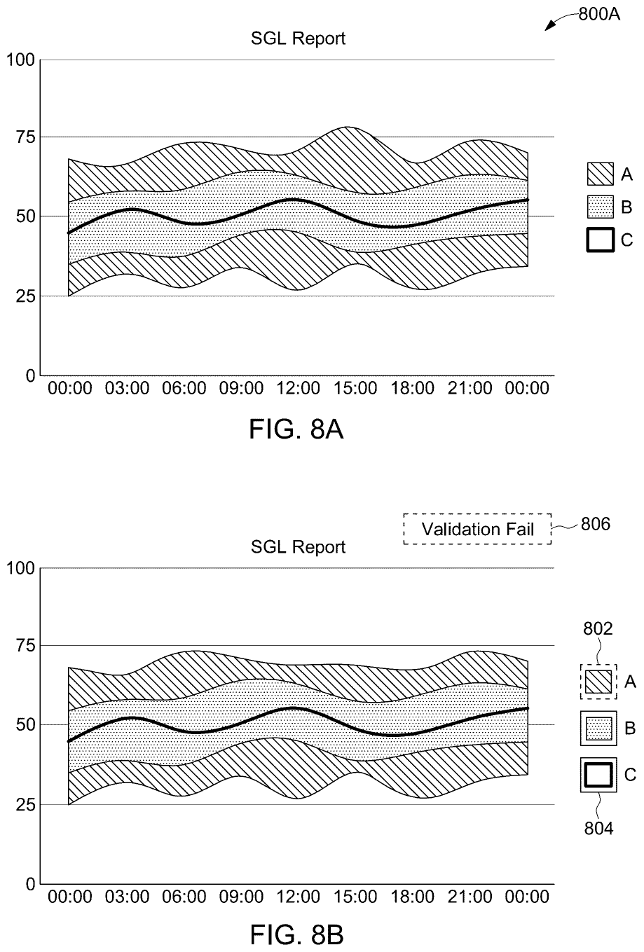

Referring now to FIGS. 8A-8B, an exemplary scenario of generating a visual explanation 800B of a failed validation result for a graph output (such as the graph output 212 and the real-time or production graph output 304) using a baseline graph 800A is illustrated, in accordance with some embodiments of the disclosure. FIGS. 8A-8B are explained in conjunction with FIGS. 1-7A-7B.

It should be noted that the graph output may be same as a graph of the visual explanation 800B excluding boundaries 802, 804 and a text 806 labelled as “Validation Fail”. The baseline graph 800A may be a reference image used for validation of the graph output. When the baseline graph 800A is compared with the graph output, a mismatch in a first area corresponding to a label “A” may be found. Thus, the label “A” may be bounded by a second type of boundary such as the boundary 802. Other labels “B” and “C” corresponding to matching areas may be bounded by a first type of boundary such as the boundary 804. The boundary 802 and the boundary 804 may be created in a red colour and a green colour, respectively. Furthermore, as a part of the visual explanation 800B, the text 806 labeled “Validation Fail” may be incorporated to signify the unsuccessful validation outcome, ensuring clarity and comprehension of the result.

This type of validation occurs between the real-time graph output and the baseline graph 800A for targeted or certain areas. The real-time or production graph output may be generated in a test environment for an application or a device to evaluate a particular test. In some embodiments, graph areas may be identified in the graph output with respect to axis (x, y) using a trained deep learning algorithm (such as the OCR). Further, the CV technique may be used to extract color, shape, text information of a plot from the graph output. The graph output and the baseline graph 800A may be a stream graph where multiple layers are a part of a graph. In some embodiments, layer and pixel level validations may be performed between the graph output and the baseline graph 800A.

The graph output may be a stream graph where different layers of streams plotted with slight differences in shading patterns which requires a validation to be performed with respect to the baseline graph 800A. In this scenario, each layer of the streams may be differentiated and validated based on colors, shapes, and patterns to provide layer level differences. In some embodiments, only one graph area plotted in an image of the graph output is required to be validated. In some other embodiments, the entire graph output is required to be validated. This may be specified in test requirements or test cases. In some embodiments, targeted graph areas may be identified for the graph output and the baseline graph 800A. This information may be then passed through a validation module (such as the validation module 208 and the validation module 310) to verify a validation criteria to generate a result as “Validation Pass” or “Validation Fail”.

Further, in some embodiments, a final report may be generated in a predefined format (for example an excel format) that specifies a layer level Region of Interest (ROI) with validation status details. This may also be highlighted in the visual explanation 800B. The baseline graph 800A may be available in a repository and details like folder path, file name, or reference information may be available in the test case document corresponding test step.

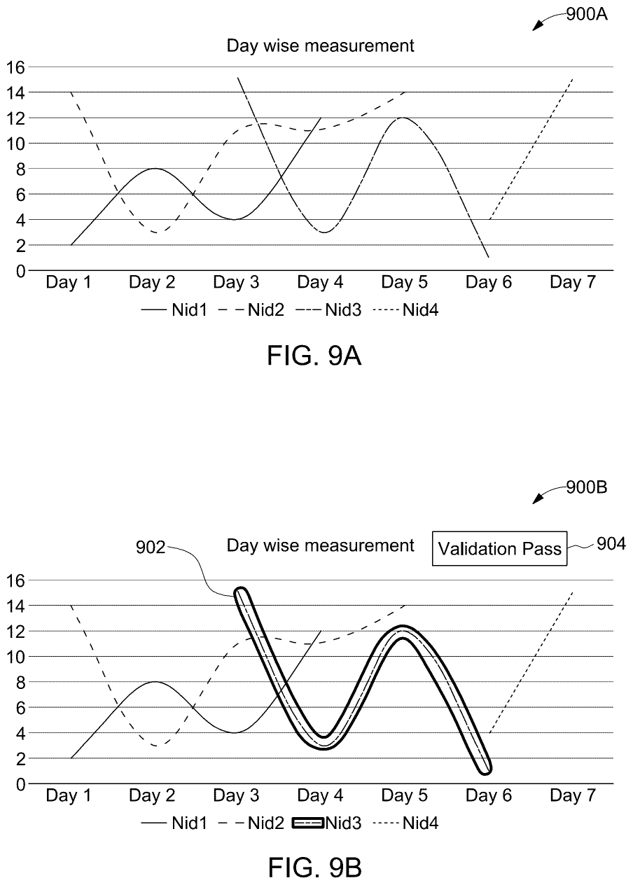

Referring now to FIGS. 9A-9B, an exemplary scenario of generating a visual explanation 900B of a successful validation result for a graph output 900A based on information within a test step is illustrated, in accordance with some embodiments of the disclosure. FIGS. 9A-9B are explained in conjunction with FIGS. 1-8A-8B.

In this type of validation, an input may be the graph output 900A that includes a text along with an image. The image may include graphs like a bar graph, a sinusoidal graph, a line graph, etc. Parameters of the graph output 900A need to be validated with respect to the information within the test step. By way of an example, the test step in a test case document may include a text or a label that needs to be detected in the graph output 900A. The label may be associated with a legend or a colour. Text content from the graph output 900A may be extracted using the deep learning OCR technique. Further, other information like colour may be extracted using the CV technique. In some embodiments, the information within the test step may be examined with the extracted text content for validation and a corresponding ROI of the text may be identified in the graph output 900A. The text within the graph output 900A may be associated with a unique color for its representation in the graph output 900A. The colour representation may be in one of a form like a line, a box, a circle etc., that may be adjacent to the text provided. A reference colour associated with the text may be detected and traced in a graph area of the graph output 900A using the CV technique. Once a match is found in the graph area, the colour associated to text may be bounded with a boundary 902. The boundary 902 may be a green colour outline. This highlighter colour is a modifiable parameter that may be selected by a tester based on a nature of the graph output 900A. A result 904 may be provided as “Validation Pass” in case of match found else reported as “Validation Fail”.

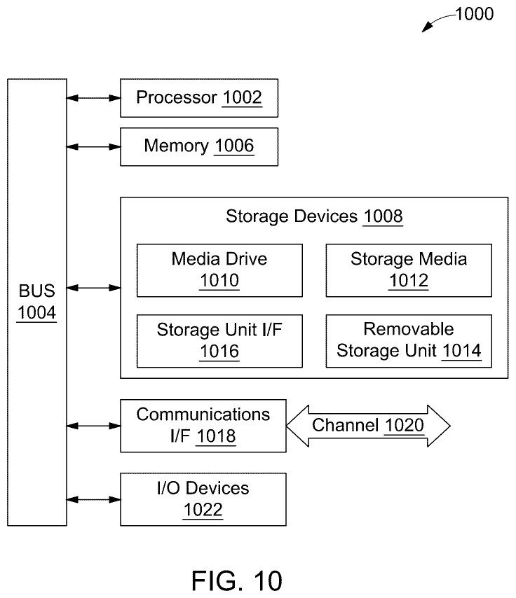

The disclosed methods and systems may be implemented on a conventional or a general-purpose computer system, such as a personal computer (PC) or server computer. Referring now to FIG. 10, an exemplary computing system 1000 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 500 may represent, for example, a user device such as a desktop, a laptop, a mobile phone, personal entertainment device, DVR, and so on, or any other type of special or general-purpose computing device as may be desirable or appropriate for a given application or environment. The computing system 1000 may include one or more processors, such as a processor 1002 that may be implemented using a general or special purpose processing engine such as, for example, a microprocessor, microcontroller or other control logic. In this example, the processor 1002 is connected to a bus 1004 or other communication medium. In some embodiments, the processor 1002 may be an Artificial Intelligence (Al) processor, which may be implemented as a Tensor Processing Unit (TPU), or a graphical processor unit, or a custom programmable solution Field-Programmable Gate Array (FPGA).

The computing system 1000 may also include a memory 1006 (main memory), for example, Random Access Memory (RAM) or other dynamic memory, for storing information and instructions to be executed by the processor 1002. The memory 1006 also may be used for storing temporary variables or other intermediate information during execution of instructions to be executed by the processor 1002. The computing system 1000 may likewise include a read only memory (“ROM”) or other static storage device coupled to bus 1004 for storing static information and instructions for the processor 1002.

The computing system 1000 may also include a storage devices 1008, which may include, for example, a media drive 1010 and a removable storage interface. The media drive 1010 may include a drive or other mechanism to support fixed or removable storage media, such as a hard disk drive, a floppy disk drive, a magnetic tape drive, an SD card port, a USB port, a micro USB, an optical disk drive, a CD or DVD drive (R or RW), or other removable or fixed media drive. A storage media 1012 may include, for example, a hard disk, magnetic tape, flash drive, or other fixed or removable medium that is read by and written to by the media drive 1010. As these examples illustrate, the storage media 1012 may include a computer-readable storage medium having stored therein particular computer software or data.

In alternative embodiments, the storage devices 1008 may include other similar instrumentalities for allowing computer programs or other instructions or data to be loaded into the computing system 1000. Such instrumentalities may include, for example, a removable storage unit 1014 and a storage unit interface 1016, such as a program cartridge and cartridge interface, a removable memory (for example, a flash memory or other removable memory module) and memory slot, and other removable storage units and interfaces that allow software and data to be transferred from the removable storage unit 1014 to the computing system 1000.

The computing system 1000 may also include a communications interface 518. The communications interface 1018 may be used to allow software and data to be transferred between the computing system 1000 and external devices. Examples of the communications interface 1018 may include a network interface (such as an Ethernet or other NIC card), a communications port (such as for example, a USB port, a micro USB port), Near field Communication (NFC), etc. Software and data transferred via the communications interface 1018 are in the form of signals which may be electronic, electromagnetic, optical, or other signals capable of being received by the communications interface 1018. These signals are provided to the communications interface 1018 via a channel 1020. The channel 1020 may carry signals and may be implemented using a wireless medium, wire or cable, fiber optics, or other communications medium. Some examples of the channel 1020 may include a phone line, a cellular phone link, an RF link, a Bluetooth link, a network interface, a local or wide area network, and other communications channels.

The computing system 1000 may further include Input/Output (I/O) devices 1022. Examples may include, but are not limited to a display, keypad, microphone, audio speakers, vibrating motor, LED lights, etc. The I/O devices 1022 may receive input from a user and also display an output of the computation performed by the processor 1002. In this document, the terms “computer program product” and “computer-readable medium” may be used generally to refer to media such as, for example, the memory 1006, the storage devices 1008, the removable storage unit 1014, or signal(s) on the channel 1020 These and other forms of computer-readable media may be involved in providing one or more sequences of one or more instructions to the processor 1002 for execution. Such instructions, generally referred to as “computer program code” (which may be grouped in the form of computer programs or other groupings), when executed, enable the computing system 1000 to perform features or functions of embodiments of the present invention.

In an embodiment where the elements are implemented using software, the software may be stored in a computer-readable medium and loaded into the computing system 1000 using, for example, the removable storage unit 1014, the media drive 1010 or the communications interface 1018. The control logic (in this example, software instructions or computer program code), when executed by the processor 1002, causes the processor 1002 to perform the functions of the invention as described herein.

Various embodiments provide a method and a system for validating a graph output generated during test case execution. The disclosed method and system may receive, in real-time, a graph output associated with a test step of a plurality of test steps within a test case. The disclosed method and system may receive contemporaneous to receiving the graph output, a test case document comprising information corresponding to the test step. Further, a first dataset corresponding to the plurality of graph regions of the graph output and a reference dataset based on the information within the test case document may be extracted. The first dataset with the reference dataset may be compared. The graph output based on the comparison and a predefined validation criteria may be validated.

The disclosure overcomes the technical problem of validating the graph output generated during test case execution. The challenges in graph validation are multifaceted, requiring significant time and effort from the testers to ensure accuracy. Text values within bars of graphs can overlap, complicating accurate extraction. To address this, the disclosure provides preprocessing methods and filtering techniques that may be applied to minimize noise and facilitate seamless data extraction. Furthermore, challenges arise when graph lines overlap or use lighter intensity colors, making it difficult to differentiate representations and trace plotted lines. This poses a problem in identifying foreground and background colors, particularly when similar light colors are used. Misidentifying representations due to color similarity is common, underscoring the need for innovative solutions. To address this, the disclosure leverages the CV and the deep learning OCR techniques. The disclosure helps seamlessly validating various types of graphs by integrating with the conventional test automation frameworks or operating standalone, eliminating a need for external files or images during testing cycles. This ensures a rapid test case execution, eliminates manual intervention, and facilitates seamless graph validation, providing clear results of “PASS” or “FAIL.” Moreover, the disclosure enhances graph validations for graphs with external files, enabling automation frameworks to execute test cases smoothly. Overall, the disclosure increases test case execution speed, eliminates manual intervention, ensures seamless graph validation, and offers easy integration with existing automation frameworks.

In light of the above mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system for validating a graph output generated during test case execution. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for validating a graph output generated during test case execution, the method comprising:
receiving, in real-time, by a validation device, a graph output associated with a test step of a plurality of test steps within a test case, wherein the test case is developed for testing of a product, and wherein the graph output comprises a plurality of graph regions;
receiving, by the validation device, contemporaneous to receiving the graph output, a test case document comprising information corresponding to the test step;
extracting, by the validation device, a first dataset corresponding to the plurality of graph regions of the graph output and a reference dataset based on the information within the test case document, wherein the first dataset is extracted using an Optical Character Recognition (OCR) technique and a Computer Vision (CV) technique;
comparing, by the validation device, the first dataset with the reference dataset; and
validating, by the validation device, the graph output based on the comparison and a predefined validation criteria.

2. The method of claim 1, wherein the first dataset corresponds to an actual result of the test step and the reference dataset corresponds to an expected result of the test step.

3. The method of claim 1, wherein extracting the reference dataset comprises:
identifying at least one of,
an image path within the information corresponding to the test step, wherein the image path points to the reference image, wherein the reference image is within an image data repository;
the reference dataset within the information corresponding to the test step; or
an external path within the information corresponding to the test step, wherein the external path points to the reference dataset, wherein the reference dataset is within an external data repository.

4. The method of claim 3, further comprising, upon identifying the image path, extracting the reference dataset from the reference image within the image data repository through the OCR technique and the CV technique.

5. The method of claim 3, further comprising, upon identifying the external path, extracting the reference dataset from the external repository.

6. The method of claim 4, wherein validating further comprises:
computing a similarity score based on a similarity between the first dataset and the reference dataset extracted from the reference image through a similarity analysis; and
validating the graph output based on the similarity score and the predefined validation criteria comprising a threshold.

7. The method of claim 1, wherein comparing further comprises identifying a mismatch in the first dataset and the reference dataset.

8. The method of claim 7, further comprising creating boundaries around one or more elements in the graph output based on a match in the first dataset and the second dataset, and the mismatch, wherein the boundaries comprise a first type of boundary indicating the match and a second type of boundary indicating the mismatch.

9. The method of claim 1, wherein validating further comprises generating a validation result comprising at least one of a successful validation or an unsuccessful validation.

10. The method of claim 9, further comprising:
generating a visual explanation of validation based on the graph output with the boundaries around the one or more elements and the validation result; and
rendering the visual explanation to a user.

11. A system for validating a graph output generated during test case execution, the system comprising:
a processor; and
a memory communicatively coupled to the processor, wherein the memory stores processor instructions, which when executed by the processor, cause the processor to:
receive, in real-time, a graph output associated with a test step of a plurality of test steps within a test case, wherein the test case is developed for testing of a product, and wherein the graph output comprises a plurality of graph regions;
receive, contemporaneous to receiving the graph output, a test case document comprising information corresponding to the test step;
extract a first dataset corresponding to the plurality of graph regions of the graph output and a reference dataset based on the information within the test case document, wherein the first dataset is extracted using an Optical Character Recognition (OCR) technique and a Computer Vision (CV) technique;
compare the first dataset with the reference dataset;
validate the graph output based on the comparison and a predefined validation criteria.

12. The system of claim 11, wherein the first dataset corresponds to an actual result of the test step and the reference dataset corresponds to an expected result of the test step.

13. The system of claim 11, wherein the processor-executable instructions cause the processor to extract the reference dataset by:
identifying at least one of,
an image path within the information corresponding to the test step, wherein the image path points to the reference image, wherein the reference image is within an image data repository;
the reference dataset within the information corresponding to the test step; or
an external path within the information corresponding to the test step, wherein the external path points to the reference dataset, wherein the reference dataset is within an external data repository.

14. The system of claim 13, wherein the processor-executable instructions further cause the processor to extract the reference dataset from the reference image within the image data repository through the OCR technique and the CV technique upon identifying the image path.

15. The system of claim 13, wherein the processor-executable instructions further cause the processor to extract the reference dataset from the external repository, upon identifying the external path.

16. The system of claim 14, wherein the processor-executable instructions cause the processor to validate the graph output by:
computing a similarity score based on a similarity between the first dataset and the reference dataset extracted from the reference image through a similarity analysis; and
validating the graph output based on the similarity score and the predefined validation criteria comprising a threshold.

17. The system of claim 11, wherein the processor-executable instructions further cause the processor to compare the first dataset with the reference dataset by identifying a mismatch in the first dataset and the reference dataset.

18. The system of claim 17, wherein the processor-executable instructions further cause the processor to create boundaries around one or more elements in the graph output based on a match in the first dataset and the second dataset, and the mismatch, wherein the boundaries comprise a first type of boundary indicating the match and a second type of boundary indicating the mismatch.

19. The system of claim 11, wherein the processor-executable instructions further cause the processor to validate the graph output by generating a validation result comprising at least one of a successful validation or an unsuccessful validation.

20. The system of claim 19, wherein the processor-executable instructions further cause the processor to:
generate a visual explanation of validation based on the graph output with the boundaries around the one or more elements and the validation result; and
render the visual explanation to a user.

21. A non-transitory computer-readable medium storing computer-executable instructions for validating a graph output generated during test case execution, the computer-executable instructions configured for:
receiving, in real-time, a graph output associated with a test step of a plurality of test steps within a test case, wherein the test case is developed for testing of a product, and wherein the graph output comprises a plurality of graph regions;
receiving, contemporaneous to receiving the graph output, a test case document comprising information corresponding to the test step;
extracting a first dataset corresponding to the plurality of graph regions of the graph output and a reference dataset based on the information within the test case document, wherein the first dataset is extracted using an Optical Character Recognition (OCR) technique and a Computer Vision (CV) technique;
comparing the first dataset with the reference dataset; and
validating the graph output based on the comparison and a predefined validation criteria.
